(19) United States
(12) Patent Application Publication
(10) Pub. No.: US 2026/0160879 A1
(43) Pub. Date: Jun. 11, 2026

(54) DETECTION METHOD, PROCESSING DEVICE, AND ELECTRONIC DEVICE

(71) Applicant: WNC Corporation, HSINCHU (TW)

(72) Inventors: GUAN-SIAN WU, HSINCHU (TW); CHIEN-YU CHEN, HSINCHU (TW); YU-AN Chen, HSINCHU (TW); Ming-Chieh Chen, HSINCHU (TW)

(21) Appl. No.: 19/392,293

(22) Filed: Nov. 18, 2025

(30) Foreign Application Priority Data
Dec. 10, 2024 (TW) 113147759

(51) Int. Cl. G01S 13/72; G01S 13/04; G01S 13/62

(52) U.S. Cl. CPC G01S 13/723; G01S 13/04; G01S 13/62

(57) ABSTRACT

A detection method, a processing device, and an electronic device. When a radar scanner is in a first mode, the processor determines, based on radar echo information data generated by the radar scanner, whether an object to be tracked appeared within a preset range. If negative, the radar scanner remains in the first mode; if affirmative, the radar scanner switches to second mode, and the processor determines whether the movement trajectory of the object to be tracked matches one of multiple preset trajectories using radar echo information data. If the movement trajectory does not match, the processor further determines whether the object to be tracked corresponds to one of several preset monitoring states. If the object to be tracked corresponds to one of the present monitoring states, the radar scanner remains in the second mode; if not, the radar scanner switches back to the first mode.

### CROSS-REFERENCE TO RELATED PATENT APPLICATION

This application claims the benefit of priority to Taiwan Patent Application No. 113147759, filed on Dec. 10, 2024. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a detection method, a processing device, and an electronic device, and more particularly, to a detection method executed by a processor of a radar scanning module, a processing device containing a processor capable of executing the detection method, and an electronic device containing a radar scanning module.

### BACKGROUND OF THE DISCLOSURE

Conventional radar scanning modules, such as doorbells, mostly have only a single scanning mode. These doorbells are mostly battery-powered, and because the radar scanning module has only one scanning mode, the radar scanning module operates in a high-power consumption manner at all times during actual use. Therefore, the battery of doorbell needs to be replaced frequently.

### SUMMARY OF THE DISCLOSURE

In response to the above-referenced technical inadequacies, the present disclosure provides a detection method, a processing device, and an electronic device for mainly improving on the issues associated with conventional radar scanning modules, which have only a single scanning mode so as to be operated in a high-power consumption manner at all times.

In one aspect, the present disclosure provides a detection method executed by a processor of a radar scanning module. The processor controls a radar scanner of the radar scanning module to switch between a first mode and a second mode. The radar scanner scans a preset range to generate radar echo information. When the radar scanner is in the first mode, the processor executes the detection method, which includes the following steps: a state change determination step: based on radar echo information, determine whether an object to be tracked appears within the preset range; if it is determined that no object to be tracked appears, maintain the radar scanner in the first mode; if it is determined that an object to be tracked appears, execute the following steps: a mode switching step: switch the radar scanner to the second mode and obtain a plurality of radar echo information data; a trajectory determination step: use the plurality of radar echo information data to determine whether a movement trajectory of the object to be tracked matches one of a plurality of preset trajectories; if it is determined that the movement trajectory does not match one of the plurality of preset trajectories, execute the following steps: a monitoring determination step: based on the plurality of radar echo information data, determine whether the object to be tracked corresponds to one of a plurality of preset monitoring-required states; if the object to be tracked corresponds to one of the plurality of preset monitoring-required states, maintain the radar scanner in the second mode and re-execute the trajectory determination step; if the movement trajectory does not correspond to any of the plurality of preset trajectories, switch the radar scanner to the first mode.

In another aspect, the present disclosure provides a processing device, which includes a processor capable of executing the detection method of the present disclosure.

In yet another aspect, the present disclosure provides an electronic device, which includes a radar scanning module and an image capture device. A processor of the radar scanning module is capable of executing the detection method of the present disclosure.

In summary, the detection method, the processing device, and the electronic device of the present disclosure allow the radar scanner to switch between the first mode and the second mode through the design of the state change determination step, the mode switching step, the trajectory determination step, and the monitoring determination step, which prevents the radar scanning mode from continuously maintaining in high-power consumption state.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a block diagram of an electronic device according to the present disclosure;

FIG. 2 is a flow chart of a detection method according to a first embodiment of the present disclosure;

FIG. 3 is a flow chart of the detection method according to a second embodiment of the present disclosure;

FIG. 4 is a flow chart of the detection method according to a third embodiment of the present disclosure;

FIG. 5 is a schematic diagram of a radar scanner and a preset range of the radar scanner associated to the detection method of the present disclosure;

FIG. 6 is a flow chart of the detection method according to a fourth embodiment of the present disclosure;

FIG. 7 is a flow chart of the detection method according to a fifth embodiment of the present disclosure;

FIG. 8 is a flow chart of the detection method according to a sixth embodiment of the present disclosure;

FIG. 9 is a flow chart of the detection method according to a seventh embodiment of the present disclosure;

FIG. 10 is a flow chart of the detection method according to an eighth embodiment of the present disclosure;

FIG. 11 is a flow chart of the detection method according to a ninth embodiment of the present disclosure; and

FIG. 12 is a partial flow chart of the detection method according to a tenth embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

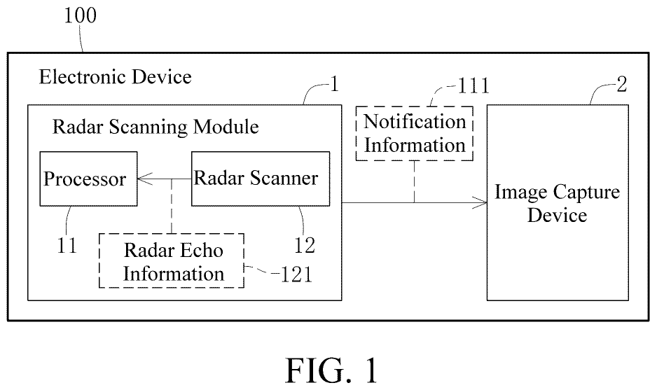

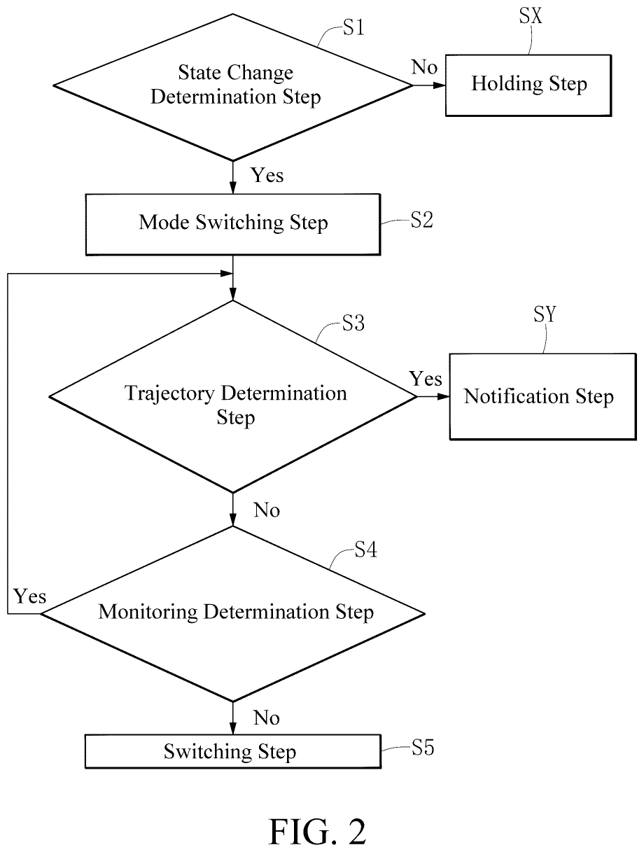

FIG. 1 is a block diagram of an electronic device of the present disclosure, and FIG. 2 is a flow chart of the detection method according to a first embodiment of the present disclosure. Referring to FIG. 1 and FIG. 2, the electronic device 100 shown in FIG. 1 includes: a radar scanning module 1 and an image capture device 2. The radar scanning module 1 includes a processor 11 and a radar scanner 12. The processor 11 is electrically connected to the radar scanner 12, and the processor 11 can control the radar scanning module 1 to switch between a first mode and a second mode.

When the radar scanner 12 operates in the first mode, it scans a preset range at intervals of a first time period. When the radar scanner 12 operates in the second mode, it scans the preset range at intervals of a second time period. The first time period is longer than the second time period. For example, when the radar scanner 12 is in the first mode, it scans the preset range once every 1000 milliseconds. When the radar scanner 12 is in the second mode, it scans the preset range once every 100 milliseconds. In other words, for the same duration, the radar scanner 12 operating in the second mode consumes more energy than when operating in the first mode. In one embodiment, when the radar scanner 12 is in the first mode and the second mode, it may scan the preset range using different resolutions, respectively.

In one specific embodiment, the electronic device 100 may be a doorbell. The processor 11 executes the detection method of the present disclosure to switch the radar scanner 12 between the first mode and the second mode.

After the radar scanner 12 scans the preset range, it will generate radar echo information 121, and the processor 11 receives the radar echo information 121. As shown in FIG. 2, when the radar scanner 12 is in the first mode, the processor 11 executes the detection method of the present disclosure, which includes the following steps:

A state change determination step S1: Based on the radar echo information 121, determine whether an object to be tracked appears within a preset range.

If it is determined that no object to be tracked appears, the processor 11 executes a holding step SX: maintaining the radar scanner 12 in the first mode.

If it is determined that an object to be tracked appears, the processor 11 executes the following steps:

A mode switching step S2: Switch the radar scanner 12 to the second mode and obtain a plurality of radar echo information data 121;

A trajectory determination step S3: Use the plurality of radar echo information data 121 to establish the object to be tracked and determine whether the movement trajectory of the object to be tracked matches one of a plurality of preset trajectories;

If it is determined that the movement trajectory does not match any of the preset trajectories, the processor 11 executes the following steps:

A monitoring determination step S4: Based on the plurality of radar echo information data 121, determine whether the object to be tracked corresponds to one of a plurality of preset monitoring-required states;

If it is determined that the object to be tracked corresponds to one of the preset monitoring-required states, the processor 11 maintains the radar scanner 12 in the second mode and re-executes the trajectory determination step S3;

If it is determined that the object to be tracked does not correspond to any of the preset monitoring-required states, the processor 11 executes a switching step S5: Switch the radar scanner 12 to the first mode.

It should be noted that after the radar scanner 12 is switched to the second mode, it will scan the preset range at intervals of the second time period (e.g., 100 milliseconds) to obtain radar scanning echo information, and the processor 11 will continue to execute the aforementioned trajectory determination step S3. Of course, the processor 11 will at least record the radar echo information generated by the radar scanner 12 the previous time, so that the processor 11 can establish the movement trajectory of the object to be tracked in the trajectory determination step S3. In other words, after the radar scanner 12 enters the second mode, it performs the trajectory determination step S3 at each interval of the second time period.

In practical application, the plurality of radar echo information data 121 obtained in the mode switching step S2 may include multiple radar echo information data 121 generated by the radar scanner 12 in the first mode and multiple radar echo information data 121 generated by the radar scanner 12 in the second mode; or it may only include multiple radar echo information data 121 generated by the radar scanner 12 in the second mode.

In practical application, after the processor 11 switched the radar scanner 12 to the second mode in the mode switching step S2, the radar scanner 12 continuously scans the preset range at intervals of the second preset time period to continuously generate radar echo information, and the processor 11 continuously receives the radar echo information data 121 transmitted by the radar scanner 12. Since the processor 11 continuously receives radar echo information data 121, the processor 11 is able to continuously convert the radar echo information data 121 into a plurality of point cloud information data and use the plurality of point cloud information data to establish the object to be tracked. In the trajectory determination step S3, the processor 11 uses the multiple positions of the object to be tracked established successively to generate the trajectory of the object to be tracked. The manner in which the movement trajectory of a tracking target is established is a well-known technique and will not be described in detail herein.

In practical application, the preset trajectory and preset monitoring-required state can be designed according to the specific application of the electronic device 100. For example, when the electronic device 100 is applied as a doorbell, one preset trajectory may be moving towards the doorbell, another preset trajectory may be moving away from the doorbell, one preset monitoring-required state may be the object to be tracked continuously appearing in the preset range, another preset monitoring-required state may be the movement trajectory of the object to be tracked continuously appearing in a preset small range in front of the doorbell.

As mentioned above, since the radar scanner 12 consumes more power when it is in the second mode compared to when it is in the first mode, the design of the state change determination step S1, mode switching step S2, trajectory determination step S3, and monitoring determination step S4 allow the radar scanner 12 to intelligently switch between the first mode and the second mode, thereby achieving the effect of monitoring while also achieving the effect of power saving.

In the trajectory determination step S3, if it is determined that the movement trajectory of the object to be tracked matches one of multiple preset trajectories using multiple radar echo information data 121, it may execute a notification step SY: Send notification information 111 to the image capture device 2 to activate the image capture device 2. After the image capture device 2 is activated, it may, for example, take photos and/or videos of the preset range.

In embodiments where the electronic device 100 does not include an image capture device 2, in the notification step SY, the processor 11 sends the notification information 111 to a preset external image capture device. After receiving the notification information, the external image capture device may take photos and/or videos of the preset range.

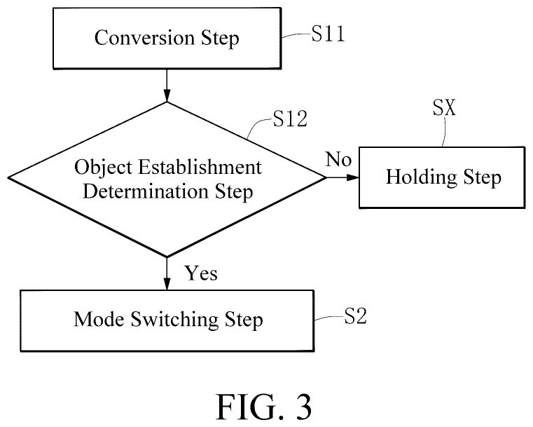

FIG. 3 is a flow chart of the detection method according to a second embodiment of the present disclosure. In the detection method of this embodiment, the process steps following the mode switching step S2 are the same as those of the first embodiment, and are therefore omitted from the drawings.

The biggest difference between the detection method of this embodiment and the first embodiment is that in the state change determination step S1, the following steps are executed:

A conversion step S11: Convert the radar echo information data into a plurality of point cloud information data;

An object establishment determination step S12: Determine whether the plurality of point cloud information data is sufficient to construct at least one object to be tracked;

If it is determined that an object to be tracked cannot be constructed, the processor 11 determines that no object to be tracked appears in the preset range, and continues to execute the aforementioned holding step SX.

If it is determined that the plurality of point cloud information data can construct an object to be tracked, the processor 11 uses the plurality of point cloud information data to establish at least one object to be tracked, and determines that an object to be tracked appears in the preset range, and continue to execute the aforementioned mode switching step S2.

In other words, in the state change determination step S1, it can be based on radar echo information data 121 to determine whether an object to be tracked can be constructed in the preset range; if it is determined that an object to be tracked cannot be constructed, the processor 11 executes the holding step SX; if it is determined that an object to be tracked can be constructed, the processor 11 executes the mode switching step S2.

In the conversion step S11, the processor may, for example, perform Fast Fourier Transform (FFT) and Constant False Alarm Rate (CFAR) calculations on radar echo information data to generate at least one point cloud information data. The manner in which the radar echo information data is converted into point cloud information data is a well-known technique and will not be described in detail herein.

In the object establishment determination step S12, if it is determined that the plurality of point cloud information data is sufficient to construct at least one object to be tracked, the processor 11 in the mode switching step S2 and trajectory determination step S3 may, through Extended Kalman Filter (EKF), Unscented Kalman Filter (UKF), Particle Filter, Interacting Multiple Model (IMM), Probabilistic Data Association Filter (PDAF), Joint Probabilistic Data Association Filter (JPDAF), Multiple Hypothesis Tracking (MHT), Track Segment Kalman Filter (TSKF), or Bayesian Filter and other means, use point cloud information data to establish the object to be tracked. Using the above means to establish the object to be tracked allow the electronic device to establish the object to be tracked with high precision and high reliability.

As described above, in the state change determination step S1, the processor 11 determines whether an object to be tracked appears in the preset range only by determining whether the radar echo information data 121 can construct at least one object to be tracked. After the radar scanner 12 switches to the second mode, the processor 11 will use multiple point cloud information data (e.g., multiple point cloud information data obtained by the radar scanner 12 in the second mode) to establish the object to be tracked. In the second mode, the radar scanner 12 will scan the preset range at a relatively higher frequency, ensuring that the processor 11 has enough radar echo information data 121 to convert into point cloud information data and construct the object to be tracked. In other words, the first mode can be regarded as a mode for environmental monitoring, while the second mode can be regarded as a mode for high-precision tracking of the object to be tracked.

In practical application, the radar scanning module 1 may include a hardware accelerator primarily used to accelerate the processor 11 in executing the aforementioned conversion step S11, object establishment determination step S12, and the task of establishing the object to be tracked using multiple point cloud information data. Specifically, the hardware accelerator may include a computing chip designed to specifically execute the aforementioned steps. The design of the hardware accelerator improves overall response speed and operational efficiency.

In one embodiment, in the object establishment determination step S12, using the Extended Kalman Filter (EKF) to generate the object to be tracked, combined with the design of the trajectory determination step S3, can ensure that the electronic device 100 accurately tracks the object to be tracked and, when necessary, send a notification to the image capture device for it to take photos and/or videos.

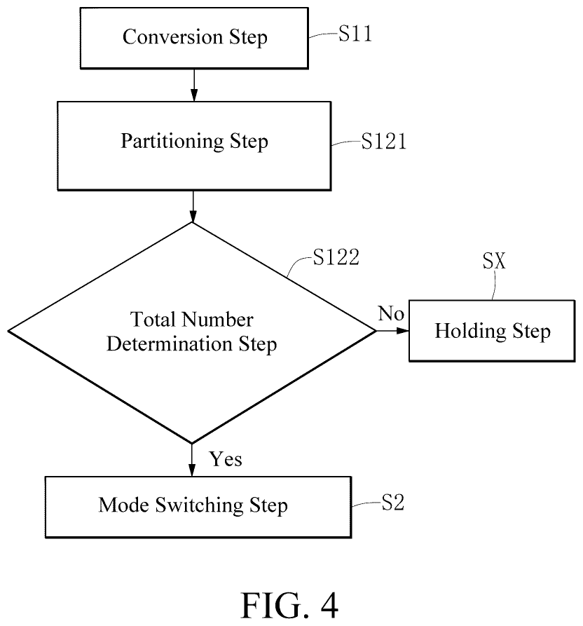

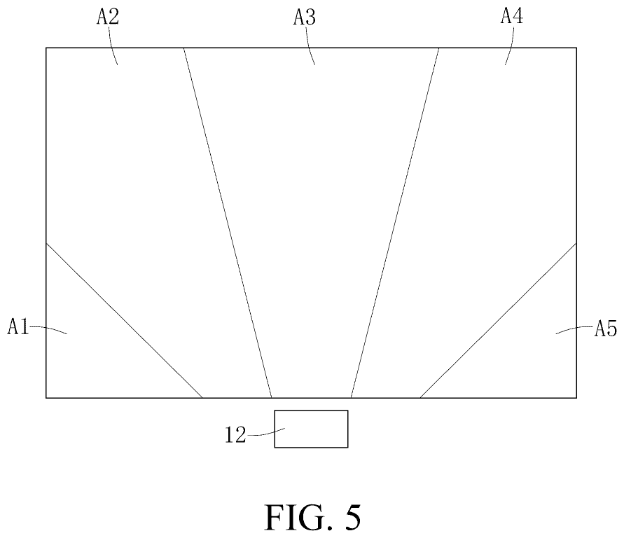

FIG. 4 is a flow chart of the detection method according to a third embodiment of the present disclosure, and FIG. 5 is a schematic diagram of the radar scanner and preset range of the present disclosure. In the detection method of this embodiment, the process steps following the mode switching step S2 are the same as those of the first embodiment, and are therefore omitted from the drawings.

Referring to FIG. 4 and FIG. 5, each of the plurality of point cloud information data at least contains one coordinate. In practice, each point cloud information data may include data such as distance (Radius), coordinate, signal strength, signal-to-noise ratio (SNR), azimuth/elevation angle, etc. The object establishment determination step S12 also includes the following steps:

A partitioning step S121: Based on the coordinate of each point cloud information data, classify the plurality of point cloud information data into at least one of a plurality of preset areas.

A total number determination step S122: Calculate, the total number of point cloud information data contained in each preset area and determine whether the total number in any one of the preset areas exceeds a corresponding preset number (i.e. a preset number corresponding to a preset area).

If it is determined that one of the total numbers exceeds its corresponding preset number, the processor 11 determines that the plurality of point cloud information data can construct the object to be tracked (i.e., the object to be tracked appears), and continues to execute the aforementioned mode switching step S2.

If it is determined that none of the total number in each preset area exceeds its corresponding preset number, the processor 11 determines that the object to be tracked cannot be constructed, and continues to execute the aforementioned holding step SX.

In practical application, different radar scanners 12 have different antenna designs and field of view (FOV), so even if the same object is at the same linear distance from the radar scanner 12, the angle between the object and the horizontal line relative to the radar scanner 12 may cause differences in the echo signal strength and signal-to-noise ratio received by the radar scanner 12. Therefore, each preset area corresponds to a preset number.

As shown in FIG. 5, assuming the preset range is divided into 5 preset areas A1, A2, A3, A4, A5, then in the total number determination step S122, the 5 preset areas correspond to 5 preset numbers, for example, 3, 4, 5, 4, 3, respectively. In other words, the closer the preset area is to the central axis of the radar scanner 12, the preset number it corresponds to is higher, and the farther the preset area is from the central axis of the radar scanner 12, the preset number it corresponds to is lower.

As described above, through the design of dividing the preset range into multiple preset areas and making multiple preset areas correspond to different preset numbers, the situation of misjudgment can be effectively reduced, thereby more accurately identifying and tracking the object to be tracked.

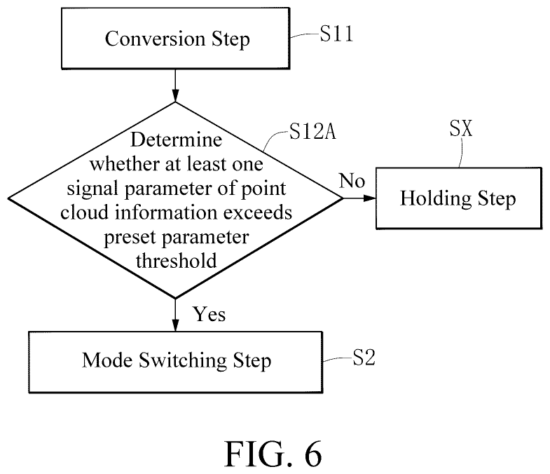

FIG. 6 is a flow chart of the detection method according to a fourth embodiment of the present disclosure. The biggest difference between this embodiment and the aforementioned second embodiment is that each point cloud information data at least contains one coordinate and one signal parameter. The signal parameter is, for example, signal strength, signal-to-noise ratio (SNR), etc.

The object establishment determination step S12A in this embodiment differs from the aforementioned second embodiment in that: in the object establishment determination step S12A of this embodiment, it is determined whether at least one signal parameter of point cloud information data exceeds a preset parameter threshold.

If it is determined that at least one signal parameter exceeds the preset parameter threshold, the processor 11 determines that the plurality of point cloud information data can construct the object to be tracked, and continues to execute the aforementioned mode switching step S2.

If it is determined that none of the signal parameter of each point cloud information data exceeds the preset parameter threshold, the processor 11 determines that the object to be tracked cannot be constructed, and continues to execute the aforementioned holding step SX.

In one specific embodiment, the signal parameter may be the signal-to-noise ratio (SNR), and the preset parameter threshold may be 15, i.e., if at least one of the point cloud information data has an SNR greater than 15, it is determined that the plurality of point cloud information data can construct the object to be tracked. Of course, the specific value of the preset parameter threshold can be designed according to actual needs.

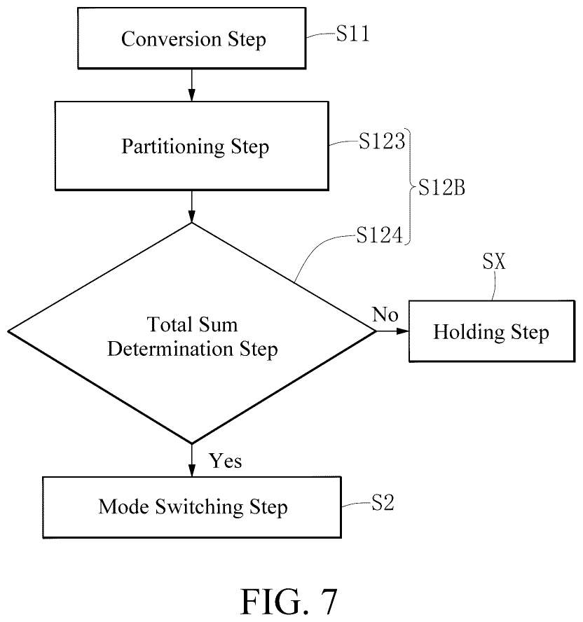

FIG. 7 is a flow chart of the detection method according to a fifth embodiment of the present disclosure. The biggest difference between this embodiment and the aforementioned second embodiment is that each point cloud information data contains at least one coordinate and one signal parameter. The signal parameter is, for example, signal strength, signal-to-noise ratio (SNR), etc.

The object establishment determination step S12B in this embodiment includes the following steps:

A partitioning step S123: Based on the coordinate of each point cloud information data, classify the plurality of point cloud information data into at least one of a plurality of preset areas.

A total sum determination step S124: Calculate the total sum of signal parameters of point cloud information data contained in each preset area and determine whether the total sum in any preset area exceeds a corresponding preset sum.

If it is determined that any of the total sums exceeds the corresponding preset sum, the processor 11 determines that the plurality of point cloud information data can construct the object to be tracked, and continues to execute the aforementioned mode switching step S2.

If it is determined that the total sum in each preset area does not exceed the corresponding preset sum, the processor 11 determines that the object to be tracked cannot be constructed, and continues to execute the aforementioned holding step SX.

In one specific embodiment, the signal parameter may be the signal-to-noise ratio (SNR), and in the total sum determination step S124, the preset sum may be 40. When the total sum of SNR of all point cloud information data in a certain area is greater than 40, it can be determined that multiple point cloud information data can construct the object to be tracked. Of course, the specific value of the preset sum can be designed according to actual needs.

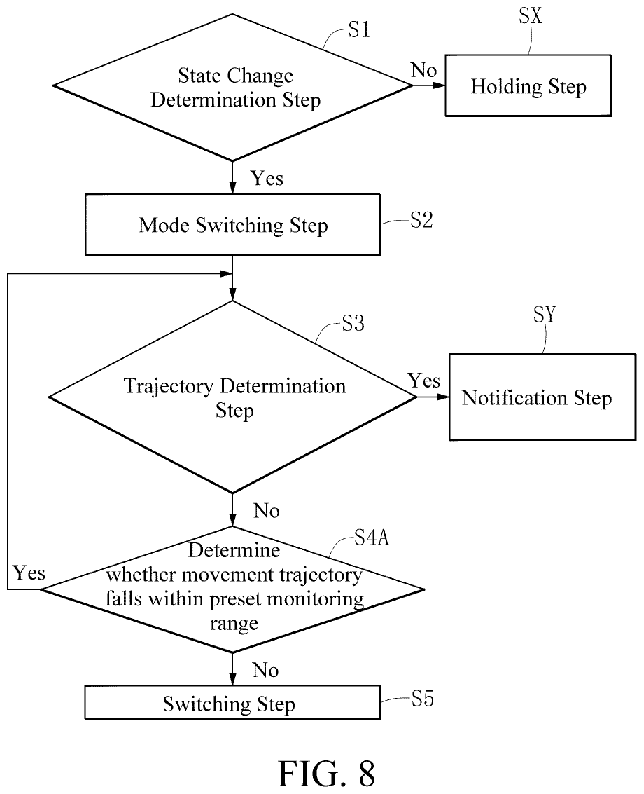

FIG. 8 is a flow chart of the detection method according to a sixth embodiment of the present disclosure.

The difference between this embodiment and the aforementioned first embodiment is that: in the monitoring determination step S4A, it is determined whether the movement trajectory falls within a preset monitoring range.

If it is determined that the movement trajectory of the object to be tracked falls within the preset monitoring range, the processor 11 determines that the object to be tracked corresponds to one of the preset monitoring-required states, and maintains the radar scanner 12 in the second mode and re-executes the trajectory determination step S3.

In practical application, the preset monitoring range is smaller than the preset range. Specifically, the preset range may refer to the maximum scanning range of the radar, and the preset monitoring range is a part of the maximum scanning range of the radar.

For example, when the electronic device 100 of the present disclosure is applied as a doorbell, the preset monitoring range may be a specific range at the doorstep, such as a range with a length of 3.5 meters and a width of 4 meters, or the preset monitoring range may be a sector area with a radius of 4 meters centered on the radar scanner. Of course, the preset monitoring range can be designed according to actual needs.

In the example of the electronic device 100 of the present disclosure being applied as a doorbell, assume that in the trajectory determination step S3, it is determined whether the movement trajectory matches: moving towards or away from the doorbell. When an unknown person moves randomly within the radar scanning range (i.e., the preset range), in the trajectory determination step S3, the movement trajectory of the unknown person will not be determined to match any preset trajectory, and in the monitoring determination step S4A, the processor 11 will determine that the movement trajectory of the unknown person (i.e., the object to be tracked) falls within the preset monitoring range, thereby keeping the radar scanner 12 continuously in the second mode. When the radar scanner 12 remains continuously in the second mode, the processor 11 will continue to use radar echo information data 121 to generate the object to be tracked and continuously track the movement trajectory of the object to be tracked.

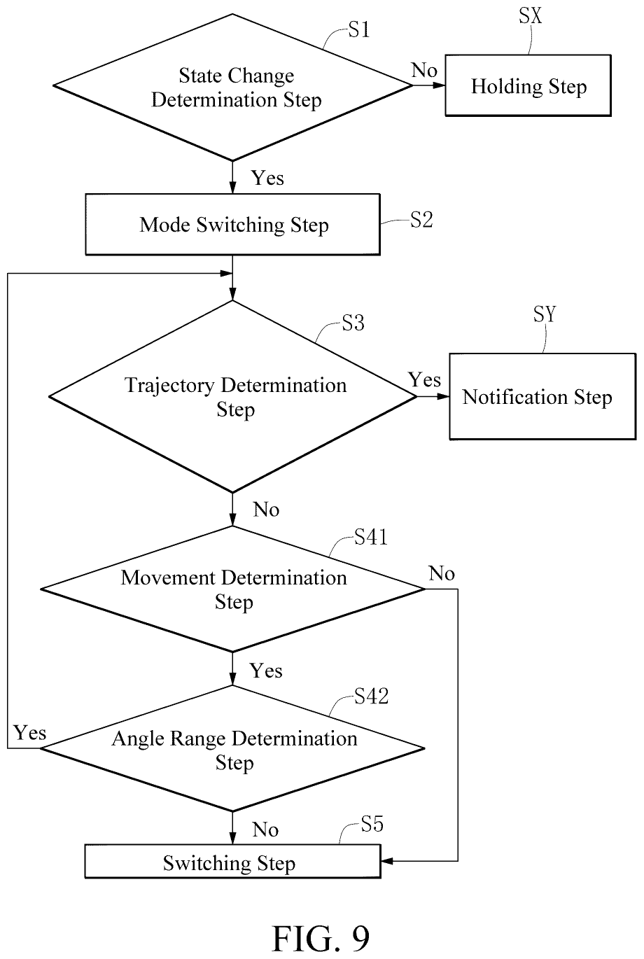

FIG. 9 is a flow chart of the detection method according to a seventh embodiment of the present disclosure. The difference between this embodiment and the aforementioned first embodiment is that: the monitoring determination step includes the following steps:

A movement determination step S41: Determine whether the object to be tracked is moving.

If it is determined that the object to be tracked is not moving, the processor 11 executes the aforementioned switching step S5 to switch the radar scanner 12 to the first mode.

If it is determined that the object to be tracked is moving, the processor 11 executes the following steps:

An angle range determination step S42: Determine whether the movement trajectory falls within a preset angle range in the preset range.

If it is determined that the movement trajectory falls within the preset angle range, the processor 11 determines the movement trajectory falls within the preset monitoring range, and the processor 11 maintains the radar scanner 12 in the second mode and re-execute the trajectory determination step S3.

If it is determined that the movement trajectory does not fall within the preset angle range, the processor 11 executes the aforementioned switching step S5 to switch the radar scanner 12 to the first mode.

As described in the previous embodiments, after the processor 11 switches the radar scanner 12 to the second mode, it will obtain radar echo information data from the radar scanner 12 at intervals of the second time period, and the processor 11 will record at least one previous radar echo information data. Therefore, in the trajectory determination step S3, the processor 11 can determine whether the trajectory of the object to be tracked matches one of the preset trajectories from the current radar echo information data obtained and at least one previously recorded radar echo information data. In practice, when the processor 11 determines in the trajectory determination step S3 that the movement trajectory of the object to be tracked does not match any preset trajectory, it may represent that the object to be tracked is stationary, the movement range of the object to be tracked is very small, the object to be tracked has disappeared, or the object to be tracked is moving, but the movement trajectory does not match any preset trajectory.

In the movement determination step S41, the criterion for determining that the object to be tracked is not moving can be designed according to actual needs. For example, in the example of the electronic device 100 being applied as a doorbell, it can be determined that the object to be tracked is not moving if the movement range is less than 0.5 meters. In different embodiments, it can also be determined that the object to be tracked is moving as long as it moves more than 0.1 meters.

The preset angle range can be designed according to actual needs and is not limited herein. In the example of the electronic device 100 being applied as a doorbell, the preset angle range may be a sector area with a radius of 5 meters and a central angle of 120 degrees centered on the doorbell.

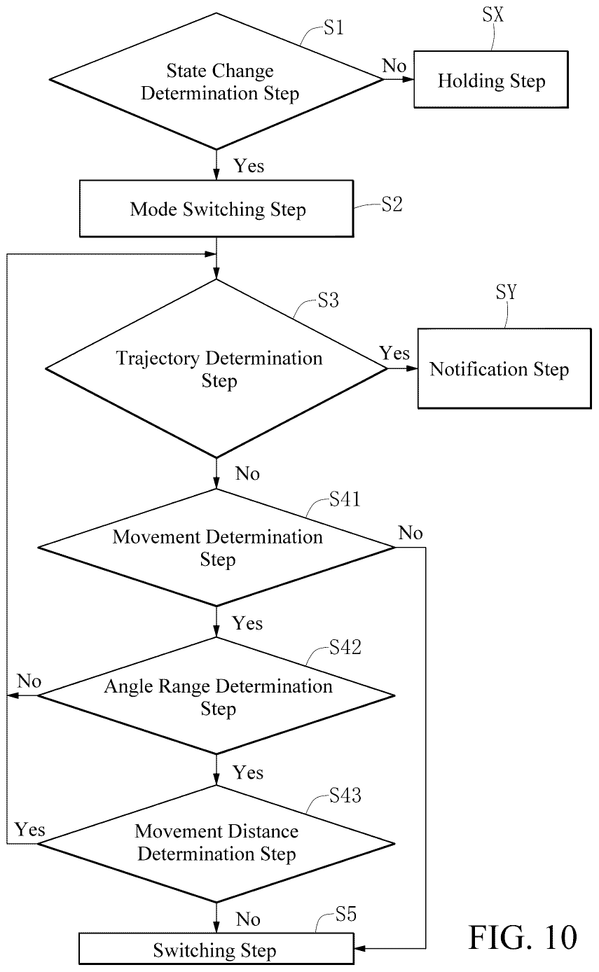

FIG. 10 is a flow chart of the detection method according to an eighth embodiment of the present disclosure. The difference between this embodiment and the aforementioned first embodiment is that: in the monitoring determination step includes the following steps:

A movement determination step S41: Determine whether the object to be tracked is moving.

If it is determined that the object to be tracked is moving, the processor 11 executes the angle range determination step S42 and the movement distance determination step S43 in sequence, or executes the movement distance determination step S43 and the angle range determination step S42 in sequence.

If it is determined that the object to be tracked is not moving, the processor 11 executes the aforementioned switching step S5 to switch the radar scanner 12 to the first mode.

The angle range determination step S42 is: Determine whether the movement trajectory falls within a preset angle range in the preset range.

If it is determined that the movement trajectory does not fall within the preset angle range, the processor 11 determines the movement trajectory falls within the preset monitoring range, and the processor maintains the radar scanner 12 in the second mode and re-executes the trajectory determination step S3.

If it is determined that the movement trajectory falls within the preset angle range, the processor 11 executes the movement distance determination step S43: Determine whether the distance between the object to be tracked and the radar scanner 12 is less than a preset distance.

If it is determined that the distance is less than the preset distance, the processor 11 determined that the movement trajectory falls within the preset monitoring range, and the processor maintains the radar scanner 12 in the second mode and re-executes the trajectory determination step S3.

If it is determined that the distance is greater than the preset distance, the processor 11 executes the aforementioned switching step S5 to switch the radar scanner 12 to the first mode.

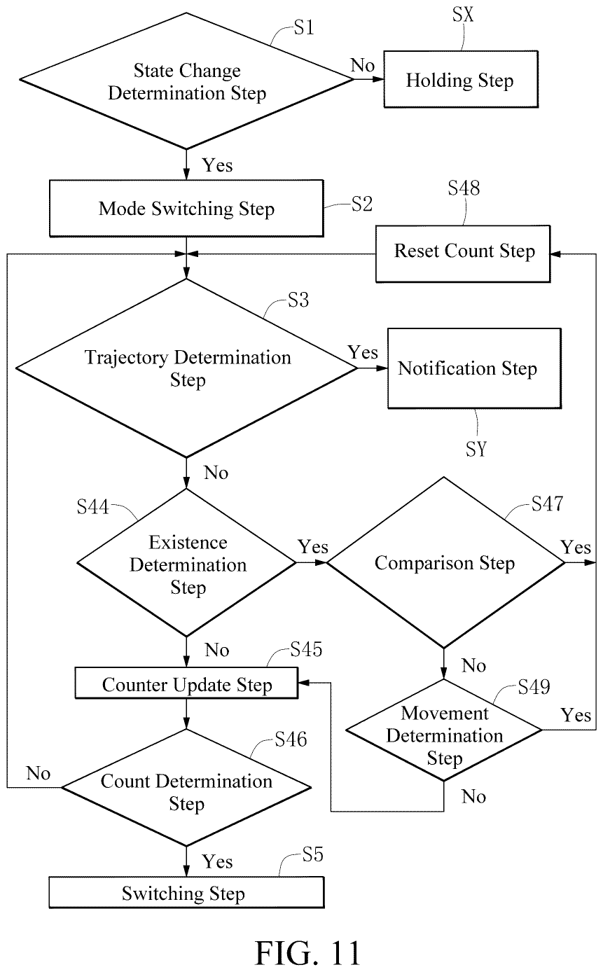

FIG. 11 is a flow chart of the detection method according to a nineth embodiment of the present disclosure. It should be explained first that, as described in the previous embodiments, in the trajectory determination step S3, the processor 11 can determine whether the trajectory of the object to be tracked matches one of the preset trajectories from the current radar echo information data obtained and at least one previously recorded radar echo information data. If it is determined that the movement trajectory of the object to be tracked does not match any preset trajectory, it may represent that the object to be tracked is stationary, the movement range of the object to be tracked is very small, the object to be tracked has disappeared, or the object to be tracked is moving but the movement trajectory does not match any preset trajectory. The biggest difference between this embodiment and the aforementioned first embodiment is that: the monitoring determination step includes the following steps:

An existence determination step S44: Determine whether the object to be tracked exists based on radar echo information data generated by the radar scanner in the second mode.

If it is determined that the object to be tracked does not exist, the processor 11 executes the following steps:

A counter update step S45: Increase the current count of a counter by 1.

A count determination step S46: Determine whether the current count exceeds a preset count.

If it is determined that the current count does not exceed the preset count, the processor 11 determines that the object to be tracked corresponds to one of the preset monitoring-required states, and the radar scanner 12 is kept in the second mode and the trajectory determination step S3 is re-executed.

If it is determined that the current count exceeds the preset count, the processor 11 executes the aforementioned switching step S5 to switch the radar scanner 12 to the first mode.

In the existence determination step S44, if it is determined that the object to be tracked exists, the processor 11 executes the following steps:

A comparison step S47: Determine whether a different object to be tracked appears in the preset range based on radar echo information data generated by the processor in the first mode and the second mode.

If it is determined that a different object to be tracked appear, the processor 11 executes the following steps:

A reset count step S48: Set the current count of the counter to an initial value and re-execute the trajectory determination step S3.

If it is determined that a different object to be tracked does not appear, the processor 11 executes the following steps:

A movement determination step S49: Determine whether the object to be tracked is moving.

If it is determined that the object to be tracked is moving, the processor 11 executes the reset count step S48.

If it is determined that the object to be tracked is not moving, the processor 11 executes the counter update step S45.

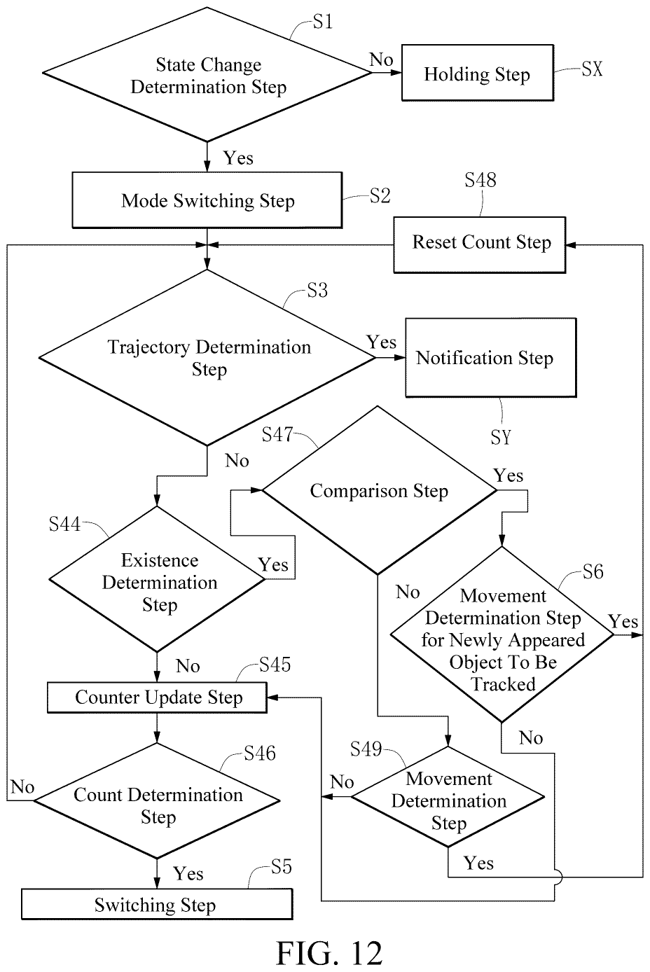

FIG. 12 is a partial flow chart of the detection method according to a tenth embodiment of the present disclosure. This embodiment is a variation of the aforementioned ninth embodiment. The flow chart of this embodiment only shows the differences between this embodiment and the aforementioned ninth embodiment. The rest of the process steps not shown in the figure is the same as the aforementioned ninth embodiment and will not be described again.

The detection method of this embodiment differs from the aforementioned ninth embodiment in that: in the comparison step S47, if it is determined that a different object to be tracked appears, a movement determination step S6 for the newly appeared different object to be tracked is first executed: Determine whether the movement magnitude of the newly appeared different object to be tracked exceeds a preset movement magnitude; if it is determined that the movement magnitude does not exceed the preset movement magnitude, the processor 11 executes the counter update step S45; if it is determined that the movement magnitude exceeds the preset movement magnitude, the processor 11 executes the reset count step S48.

For example, in the example of the electronic device of the present disclosure being applied as a doorbell, in the aforementioned comparison step S47, the newly appeared object to be tracked may be a swaying tree in front of the doorbell. Since the swaying tree is not an object that needs monitoring, the preset movement magnitude can be set as the movement magnitude of the swaying tree, thereby preventing the doorbell from monitoring the swaying tree. Of course, the design of the preset movement magnitude can vary according to actual needs and is not limited to the example of the swaying tree.

In one embodiment, the detection method of the present disclosure can be pre-stored in the processor of the processing device of the present disclosure in the form of firmware, and the processor can execute the detection method. The processing device can be manufactured, implemented, or sold independently.

In view of the above, one beneficial effect of the detection method, the processing device, and the electronic device of the present disclosure is that, through the design of the state change determination step, the mode switching step, the trajectory determination step, the monitoring determination step, etc., can determine whether the radar scanner needs to automatically switch back from the second mode to the first mode or extend the time of the second mode based on the changes, the trajectory, and the stay position of the object to be tracked. This allows the radar scanner to appropriately switch between the first mode and the second mode, thereby enabling the radar scanning module to achieve the effect of energy saving while ensuring monitoring quality, thus reducing the frequency of battery replacement.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A detection method executed by a processor of a radar scanning module when a radar scanner of the radar scanning module operates in a first mode, wherein the processor controls the radar scanner to switch between the first mode and a second mode, the radar scanner being configured to scan a preset range to generate radar echo information data, the detection method comprising:
determining, based on the radar echo information data, whether an object to be tracked appears within the preset range;
if the object to be tracked does not appear, maintaining the radar scanner in the first mode; and
if the object to be tracked appears, switching the radar scanner to the second mode and obtaining a plurality of radar echo information data, and determining, based on the plurality of radar echo information data, whether a movement trajectory of the object to be tracked matches one of a plurality of preset trajectories;
if the movement trajectory does not match, determining, based on the plurality of radar echo information data, whether the object to be tracked corresponds to one of a plurality of preset monitoring-required states;
if the object to be tracked corresponds to one of the preset monitoring-required states, maintaining the radar scanner in the second mode and re-executing the trajectory determination; and
if the object to be tracked does not correspond to any of the preset monitoring-required states, switching the radar scanner to the first mode.

2. The detection method according to claim 1, wherein the determination of whether the object to be tracked corresponds to one of the plurality of preset monitoring-required states comprises:
determining whether the movement trajectory falls within a preset monitoring range;
if the movement trajectory falls within the preset monitoring range, determining that the object to be tracked corresponds to one of the preset monitoring-required states.

3. The detection method according to claim 2, wherein the determination of whether the object to be tracked corresponds to one of the plurality of preset monitoring-required states further comprises:
determining whether the object to be tracked is moving;
if the object to be tracked is moving, determining whether the movement trajectory falls within a preset angle range in the preset range;
if the movement trajectory falls within the preset angle range, determining that the movement trajectory falls within the preset monitoring range.

4. The detection method according to claim 2, wherein the determination of whether the object to be tracked corresponds to one of the plurality of preset monitoring-required states further comprises:
determining whether the object to be tracked is moving;
if the object to be tracked is moving, determining whether a distance between the object to be tracked and the radar scanner is less than a preset distance;
if the distance is less than the preset distance, determining that the movement trajectory falls within the preset monitoring range.

5. The detection method according to claim 2, wherein the determination of whether the object to be tracked corresponds to one of the plurality of preset monitoring-required states further comprises:
determining whether the object to be tracked is moving;
if the object to be tracked is moving,
determining whether the movement trajectory falls within a preset angle range in the preset range; and
determining whether a shortest distance between the object to be tracked and the radar scanner is less than a preset distance;
if the movement trajectory falls within the preset angle range, determining that the movement trajectory falls within the preset monitoring range; and
if the shortest distance is less than the preset distance, determining that the movement trajectory falls within the preset monitoring range.

6. The detection method according to claim 2, wherein the preset monitoring range is smaller than the preset range.

7. The detection method according to claim 1, wherein the determination of whether the object to be tracked corresponds to one of the plurality of preset monitoring-required states comprises:
determining, based on the plurality of radar echo information data generated by the radar scanner in the second mode, whether the object to be tracked exists;
if the object to be tracked does not exist, increasing a current count of a counter by 1, and determining whether the current count exceeds a preset count;
if the current count does not exceed the preset count, determining the object to be tracked corresponds to one of the preset monitoring-required states.

8. The detection method according to claim 7, wherein the determination of whether the object to be tracked exists comprises:
if the object to be tracked exists, determining, based on radar echo information data respectively generated by the processor in the first mode and the second mode, whether a different object to be tracked appears in the preset range;
if the different object to be tracked appears, setting the current count of the counter to an initial value and re-executing the trajectory determination; and
if the different object to be tracked does not appear, determining whether the object to be tracked is moving;
if the object to be tracked is moving, setting the current count of the counter to the initial value and re-executing the trajectory determination; and
if the object to be tracked is not moving, increasing the current count of the counter by 1.

9. The detection method according to claim 8, wherein the determination of whether the different object to be tracked appears in the preset range comprises:
if the different object to be tracked appears, determining, at first, whether a movement magnitude of the newly appeared different object to be tracked exceeds a preset movement magnitude;
if the movement magnitude does not exceed the preset movement magnitude, increasing the current count of the counter by 1; and
if the movement magnitude exceeds the preset movement magnitude, setting the current count of the counter to the initial value and re-executing the trajectory determination.

10. The detection method according to claim 1, wherein the determination of whether the object to be tracked appears within the preset range comprises:
converting the radar echo information data into a plurality of point cloud information data; and
determining whether the plurality of point cloud information data is sufficient to construct at least one object to be tracked;
if the plurality of point cloud information data is not sufficient to construct the at least one object to be tracked, determining that the object to be tracked does not appear in the preset range; and
if the plurality of point cloud information data is sufficient to construct the at least one object to be tracked, establishing the at least one object to be tracked by using the plurality of point cloud information data, and determining that the object to be tracked appears in the preset range.

11. The detection method according to claim 10, wherein each of the plurality of point cloud information data comprises a coordinate, and the determination of whether the plurality of point cloud information data is sufficient to construct the at least one object to be tracked comprises:
classifying, based on the coordinate of each of the plurality of point cloud information data, the plurality of point cloud information data into at least one of a plurality of preset areas; and
calculating, for each of the plurality of preset areas, a total number of the point cloud information data included therein, and determining whether the total number in any one of the plurality of preset areas exceeds a corresponding preset number;
if the total number exceeds the corresponding preset number, determining that the plurality of point cloud information data is sufficient to construct the at least one object to be tracked; and
if the total number in each of the plurality of preset areas does not exceed the corresponding preset number, determining that the plurality of point cloud information data is not sufficient to construct the at least one object to be tracked.

12. The detection method according to claim 11, wherein the preset area that is closer to a central axis of the radar scanner corresponds to a greater preset number, and the preset area that is farther from the central axis of the radar scanner corresponds to a smaller preset number.

13. The detection method according to claim 10, wherein each of the plurality of point cloud information data comprises a signal parameter, and the determination of whether the plurality of point cloud information data is sufficient to construct the at least one object to be tracked comprises:
determining whether at least one signal parameter of the plurality of point cloud information data exceeds a preset parameter threshold;
if the at least one signal parameter exceeds the preset parameter threshold, determining that the plurality of point cloud information data is sufficient to construct the at least one object to be tracked; and
if none of the signal parameters of the plurality of point cloud information data exceeds the preset parameter threshold, determining that the plurality of point cloud information data is not sufficient to construct the at least one object to be tracked.

14. The detection method according to claim 10, wherein each of the plurality of point cloud information data comprises a coordinate and a signal parameter, and the determination of whether the plurality of point cloud information data is sufficient to construct the at least one object to be tracked comprises:
classifying, based on the coordinate of each of the plurality of point cloud information data, the plurality of point cloud information data into at least one of a plurality of preset areas; and
calculating, for each of the plurality of preset areas, a total sum of the signal parameters included therein, and determining whether the total sum in any one of the plurality of preset areas exceeds a corresponding preset sum;
if the total sum exceeds the corresponding preset sum, determining that the plurality of point cloud information data is sufficient to construct the at least one object to be tracked; and
if the total sum in each of the plurality of preset areas does not exceed the corresponding preset sum, determining that the plurality of point cloud information data is not sufficient to construct the at least one object to be tracked.

15. The detection method according to claim 1, wherein the radar scanner scans the preset range and generates the radar echo information data at intervals of a first time period when operating in the first mode and at intervals of a second time period when operating in the second mode; the first time period is greater than the second time period; wherein, the determination of whether the movement trajectory of the object to be tracked matches one of the plurality of preset trajectories comprises: if the movement trajectory matches one of the plurality of preset trajectories, sending notification information.

16. A processing device comprising: a processor capable of executing the detection method according to claim 1.

17. An electronic device comprising: a radar scanning module and an image capture device, wherein a processor of the radar scanning module is capable of executing the detection method according to claim 1.

18. The electronic device according to claim 17, wherein the determination of whether the movement trajectory of the object to be tracked matches one of the plurality of preset trajectories comprises: if the movement trajectory matches one of the plurality of preset trajectories, sending notification information to the image capture device to activate the image capture device.
